(19) United States
(12) Patent Application Publication
(10) Pub. No.: US 2013/0191274 A1
(43) Pub. Date: Jul. 25, 2013

(54) METHOD AND SYSTEM FOR INTEGRATING MARKET CREDIT UNITS (MCUs) TO REAL MONEY

(71) Applicant: SRIRAM KARRI, Hyderabad (IN)

(72) Inventor: SRIRAM KARRI, Hyderabad (IN)

(21) Appl. No.: 13/745,748

(22) Filed: Jan. 19, 2013

(51) Int. Cl. G06Q 20/06

(52) U.S. Cl. CPC G06Q 20/065
USPC 705/39

(57) ABSTRACT

In accordance with an example embodiment a method and system for integrating marketplace credit units (MCUs) to real money is provided. The method includes receiving a first quantity of a first currency. The method further comprises, electronically converting the first quantity to a first set of marketplace credit units (MCUs), the first set having value equivalent to that of the first quantity upon encashment. Further, the method comprises facilitating a transaction using the first set or a portion of the first set in a marketplace.

### TECHNICAL FIELD

The present technology generally relates to integrating market credit units (MCUs) to real money, and more particularly, relates to integrating market credit units (MCUs) to real money to enable transactions, exchange of value, rewards for loyalty, and other online and offline transactions.

### BACKGROUND

Conventionally, points, credits and such other units are used within games, loyalty programs, electronic service credits, ecommerce portals, virtual systems, web environments, and gaming centers like casinos for various purposes. The units are created by context owners, are unreal, and have no value outside the context. The units are not convertible, cannot be traded across different entities or people and are not backed by any real value across the economic zone. Even if the units have some real value then these are not acceptable across a large set of establishments but a small single establishment. Further, all such units are limited in duration or have a fixed expiry period. For example, people exchange real money for a set of slot coins for a game in a casino and return them at the end of their gaming round in the casino at the time of exit, in a few hours.

### SUMMARY OF SOME EMBODIMENTS

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

In one embodiment, the proposed technology integrates marketplace credit units (MCUs) to real money to enable transactions, exchange of value, rewards for loyalty, and other online and offline transactions.

In an example, a disclosed method includes receiving a first quantity of a first currency, and electronically converting the first quantity to a first set of marketplace credit units (MCUs), where the first set has a value equivalent to that of the first quantity upon encashment. The method further includes facilitating a transaction using the first set or a portion of the first set in a marketplace.

In an example, a disclosed non-transitory, computer-readable storage medium storing includes computer-executable program instructions to implement receiving a first quantity of a first currency. The medium further includes computer-executable program instructions to implement converting the first quantity to a first set of marketplace credit units (MCUs). The first set has value equivalent to that of the first quantity upon encashment. Each MCU has a unique identifier and has capability of facilitating a transaction in a marketplace.

In an example, a disclosed system includes a memory to store instructions. The system further includes a processor responsive to stored instructions to perform receiving a first quantity of a first currency. The processor also converts the first quantity to a first set of marketplace credit units (MCUs). The first set has value equivalent to that of the first quantity upon encashment. Each MCU has a unique identifier. The processor further facilitates a transaction using the first set or a portion of the first set in a marketplace.

In an example, a disclosed method includes receiving a first quantity of a first currency from a first user. The method also includes electronically converting the first quantity to a first set of marketplace credit units (MCUs), the first marketplace credit unit having value equivalent to that of the first quantity. Further, the method includes facilitating a first transaction using a first sub-set of the first set at a first merchant facility. The method also includes facilitating a second transaction using a second sub-set of the first set at a second merchant facility, the second merchant facility being different than the first merchant facility. Further, the method includes receiving at least one of the first sub-set or the second sub-set for redemption, and providing equivalent of the first currency corresponding to the at least one of the first sub-set or the second sub-set.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 illustrates a flow diagram of interaction of a user in a marketplace, in accordance with an exemplary embodiment;

FIG. 2 illustrates a flow diagram of interaction of the user in the marketplace and a merchant in the marketplace, in accordance with an exemplary embodiment;

FIG. 3a illustrates a flow diagram of interaction of the user and multiple merchants in the marketplace to facilitate a transaction, in accordance with an exemplary embodiment;

FIG. 3b illustrates a flow diagram of interaction of multiple users and the merchant in the marketplace to facilitate a transaction, in accordance with an exemplary embodiment;

FIG. 4 illustrates a flow diagram of interaction of the merchant in the marketplace to offer MCUs to multiple users, in accordance with an exemplary embodiment;

FIG. 5 illustrates flow diagram of infusing more number of MCUs in the marketplace by infusing more money in the marketplace, in accordance with an exemplary embodiment;

FIG. 6 illustrates a flow diagram of changing backing of value of the MCUs from money to assets, in accordance with an exemplary embodiment;

FIG. 7 illustrates a flow diagram of revenue settlement cycle between the user and the merchant in the marketplace, in accordance with an exemplary embodiment;

FIG. 8 illustrates a flow diagram of changing denomination of the MCUs in the marketplace, in accordance with an exemplary embodiment;

FIG. 9 is a flowchart depicting an exemplary method of enabling a transaction in the marketplace, in accordance with an exemplary embodiment; and

FIG. 10 is a flowchart depicting an exemplary method of enabling multiple transactions in the marketplace, in accordance with another exemplary embodiment.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

Broadly, embodiments of the present technology disclose a method and system to integrate marketplace credit units (MCUs) to real money. The system and method enables users of various online communities, web portals, social networks, email services, e-commerce sites, web sites, all kinds of electronic services or the offerings of all kinds of online or offline businesses, to collect MCUs against cash from an entity providing such service. The MCUs are valid for redemption at the online and offline integrated marketplace of the entity. The MCUs can be redeemed anytime. The users can also collect the MCUs directly from an online community, web portal, social network, email service, e-commerce site, web site, any electronic service, or an offering of any online or offline business based on usage. The users can then use MCUs for making purchases and availing discounts, with all participating businesses through the online and offline integrated marketplace. The users can also make normal purchases from businesses and collect rewards from them in the form of the MCUs.

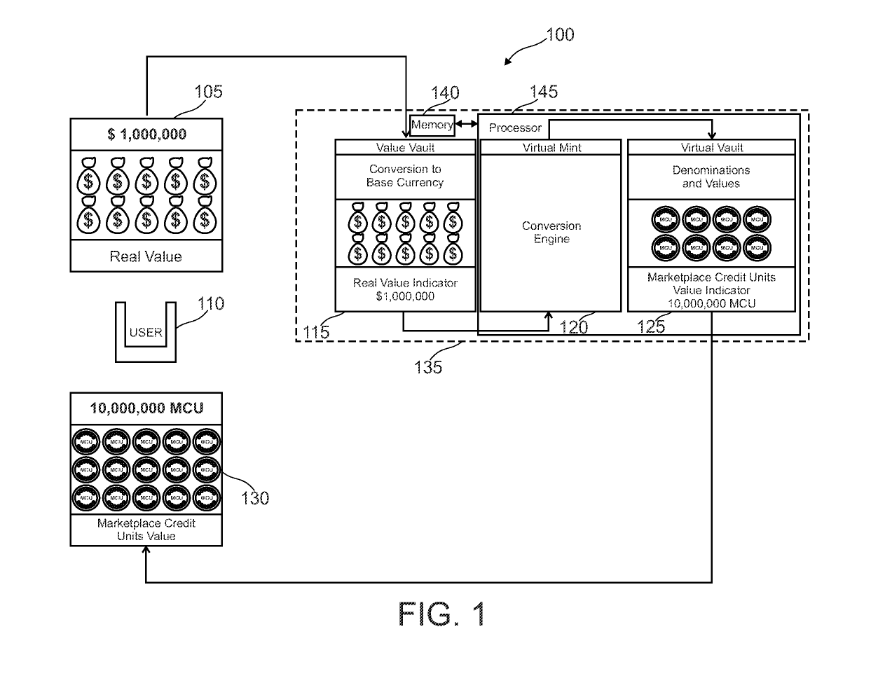

FIG. 1 illustrates a flow diagram 100 of interaction of a user in a marketplace, in accordance with an exemplary embodiment. The marketplace can be defined as an online or offline market where money exchange, credit exchange, unit exchange and good exchange happens between participating business entities and users. The flow diagram 100 is explained using a system 135. The system 135 includes a vault 115. A user 110 deposits money 105 (first quantity of first currency) in the vault 115. A conversion engine 120 converts the money 105 into MCUs 130 (first set of MCUs). The information about the MCUs 130 is maintained in virtual vault 125. The virtual vault 125 sorts the MCUs 130 into different denominations. For example, if the money 105 is USD 30 and 10 MCUs equal USD 1 then the MCUs 130 may include 20 MCU of denomination 5 and 10 MCU of denomination 20.

In one example, the user 110 can obtain MCUs by buying it online or offline using various paying mechanisms, including cash, cheque, bankers' cheques, credit or debit cards, online bank transfer of money, among others, and get account loaded with MCUs. A merchant too can buy MCUs by any mechanism of payment.

Table 1 below illustrates an example of how the MCUs are created when USD 1 million is introduced into the marketplace.

TABLE 1

| Denomination | Real Value of | Numbers | Virtual | Total Real |
|---|---|---|---|---|
| of MCU | each MCU | Minted | Value | Value |
| 1 | 10 cents | 2,000,000 | 2,000,000 | 200,000 |
| 10 | USD 1 | 200,000 | 2,000,000 | 200,000 |
| 20 | USD 2 | 50,000 | 1,000,000 | 100,000 |
| 50 | USD 5 | 20,000 | 1,000,000 | 100,000 |
| 100 | USD 10 | 10,000 | 1,000,000 | 100,000 |
| 500 | USD 50 | 2,000 | 1,000,000 | 100,000 |
| 1,000 | USD 100 | 1,000 | 1,000,000 | 100,000 |
| 5,000 | USD 500 | 200 | 1,000,000 | 100,000 |
| | | | 10 million | USD 1 million |
| | | | MCUs | |

In illustrated TABLE 1, a virtual to real proportion is fixed at 10:1. The proportion indicates a sum of 10 million MCUs. The sorting involves breaking the 10 million MCUs into specific value denominations, for example 10 cents, USD 1, USD 2, USD 5, USD 10, USD 50, USD 100, USD 500, etc. These denominations are the actual value each MCU will hold.

TABLE 1 illustrates, as an example, how the system 135 creates MCUs in virtual face denomination value of MCU 1, MCU 10, MCU 20, MCU 50, MCU 100, MCU 500, MCU 1000, and MCU 5,000, in numbers listed in column 3, to ensure the total value of all MCUs equals the real value introduced into the system 135.

An MCU is a unit that is tradable at different online and offline marketplaces. For example, the user 110 can make a payment using MCUs, receive MCU as reward from various online portals etc. In one aspect, the MCU can be termed as virtual money. A unique identifier for each MCU is generated and associated with the MCU. The MCU is stored in at least one of an electronic card, smart card, mobile phone, electronic chip, and account of the user 110.

In one example, a unique identifier is added to each MCU and each denomination unit as a tag or a serial number or a meta or hidden element. The unique identifier is added at the time of conversion or creation of the MCUs and denominations. The unique identifier helps identify each MCU and denomination. The unique identifier further helps to track movement of MCU across users or merchants. The unique identifier also adds a good level of auditory mechanism and fraud prevention.

The MCUs in various denominations are added to account of the user 110 or a merchant and may be also stored in memory of an electronic card or phone or device. The smart card or the electronic card can be used to transact using smart card systems or point of sale or near field communication or other systems and portals. Thus, the MCUs acts like a wallet including notes which have unique identifiers printed on them. In the system 135, the movement is always tracked, and proactive fraud detection is possible since the MCUs move only within the marketplace and within the system 135.

When some denominations are changed and therefore some killed, the unique identifiers of the MCUs killed are also stored for audit purposes. Also within the system 135, at any point of time, a particular MCU can be disabled from being used or accepted as bonafide. This is achieved creating a built in system of bonafide-verification security system, wherein, at every transaction, each MCU is verified before being accepted along the chain of value transfer.

The value of MCUs is equivalent to that of the money 105. In one example, if the money 105 is USD 1,000,000 and the MCUs 130 are 10,000,000 in number, then the value of 10 MCUs is USD 1. Overall, the value of the MCUs 130 equals that of USD 1,000,000. The system 105 issues the MCUs 130 to the user 110.

The vault 115, the conversion engine 120 and the virtual vault 125 are locked. The value locked in real terms in the vault 115, and the total worth of the MCUs introduced or released into the system 135 are locked. At any given point of time, the sum total of real and MCUs are open to audit and a real-time measure is given. Any new introduction or withdrawal of real value into or from the vault 115 triggers an equivalent impact of additional release or withdrawal of the MCUs.

The locking ensures the objectives of keeping the total value exchange system as being backed by real currency and thus has a fixed real value. At any given point of time, any recipient is assured of being given back a real value or currency in exchange of the MCUs.

In one embodiment, the system 135 can be owned by an entity and can be provided as an online or offline service. In one example, the system 135 can include two computer servers and one physical vault (the vault 115). One computer server keeps track of money stored in the vault 115. The other computer server handles the conversion aspect and the MCUs 130. In another embodiment, the system 135 can be owned by a merchant having an online website, for example e-commerce portals. The merchant can provide a new purchase experience by combing the concept of MCUs with existing website. Examples of the entity include but are not limited to online communities, web portals, social networks, email services, e-commerce sites, web sites, loyalty programs, electronic service credits, virtual systems, web environments, gaming centers like casinos, and all kinds of electronic services or the offerings of all kinds of online and offline businesses. The system 135 creates a juxtaposition of virtual world commerce with real world business, in a seamless fashion, enabling a new real-cum-virtual integrated marketplace and a method of exchanging value within the same. The MCUs can be sold to individuals, merchants, online communities, web portals, social networks, email services, c-commerce sites, web sites, electronic service providers and those running all kinds of online or offline businesses to be used for various purposes such as rewarding, collection and redeeming of loyalty rewards, giving loans, earning interests, gifting, managing discount offers and the like.

In one example, the system 135 includes a memory 140 and a processor 145 to perform the functions described herein. The processor 145 is responsive to the instructions present in the memory 140 to perform the functions. In one example, the processor 145 includes and performs the functions of the converting engine 120 and the virtual vault 125.

The user 110 and the system 135 can interact with each other via a network (not shown). The examples of the network include but are not limited to, Internet, Wide Area Network (WAN), Local Area Network (LAN), and the like. Many such users can be there. The user 110 can deposit money by any mode, for example physically visiting office of the entity, online transfer, net banking, and credit card payment.

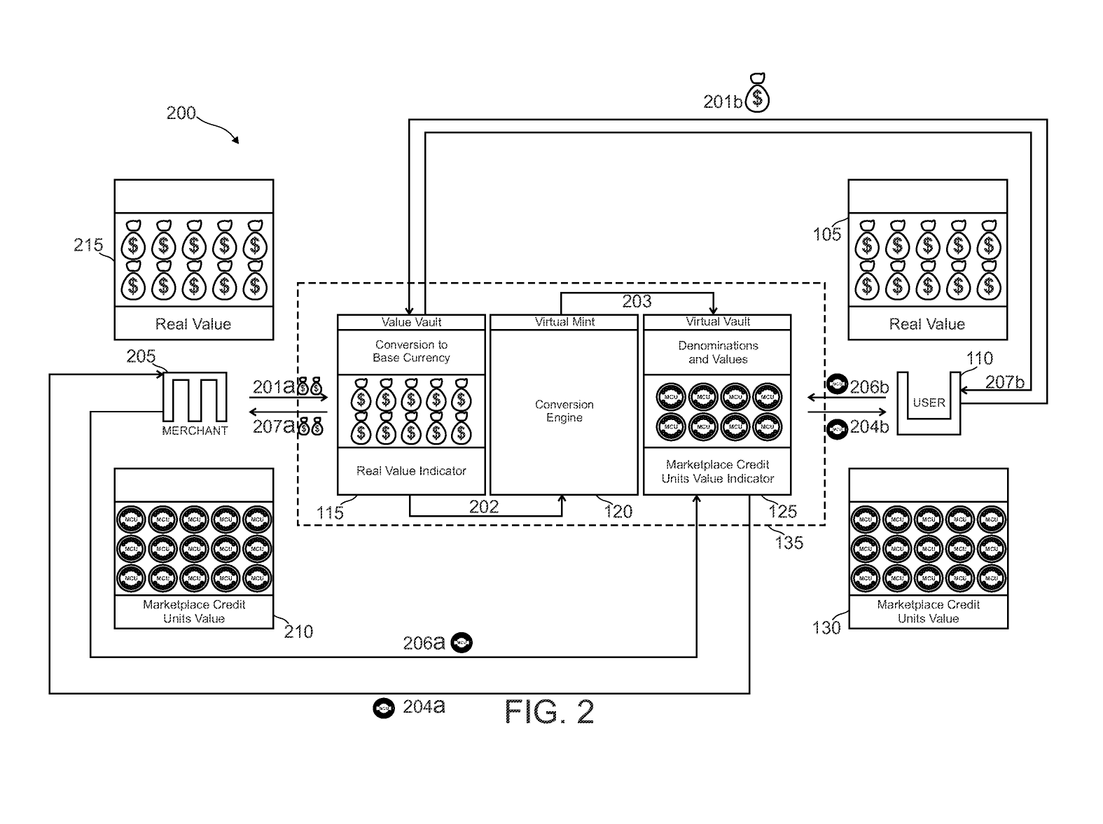

FIG. 2 illustrates a flow diagram 200 of interaction of the user 110 in the marketplace and a merchant in the marketplace, in accordance with one embodiment of the present technology. The flow diagram 200 depicts flow of MCUs among a merchant 205 and the system 135, and the user 110 and the system 135. The merchant 205 deposits money 215 in the vault 115 (step 201a). The money 215 is sent to the conversion engine 120 (step 202). The conversion engine 120 converts the money 215 into the MCUs 210 (step 203) and the virtual vault 125 issues the MCUs 210 having value equivalent to that of the money 215 to the merchant 205 (step 204a). The denominations for the MCUs 210 are managed by the virtual vault 125. The merchant 205 can at any time redeem the MCUs 210 or a portion of the MCUs 210 (step 206a). The money equivalent to the MCUs redeemed is then provided to the merchant 205 by the system 135 (step 207a).

A similar sort of workflow exists for the user 110. The user 110 deposits money 105 in the vault 115 (step 201b). The money 105 is sent to the conversion engine 120 (step 202). The conversion engine 120 converts the money 105 into the MCUs 130 (step 203) and the virtual vault 125 issues the MCUs 130 having value equivalent to that of the money 105 to the user 110 (step 204b). The denominations for the MCUs 130 are managed by the virtual vault 125. The user 110 can at any time redeem the MCUs 130 or a portion of the MCUs 130 (step 206b). The money equivalent to the MCUs redeemed is then provided to the user 110 by the system 135 (step 207b).

The steps for the user 110 and the merchant 205 can be performed in any order. For example, the steps may be performed one after another or simultaneously.

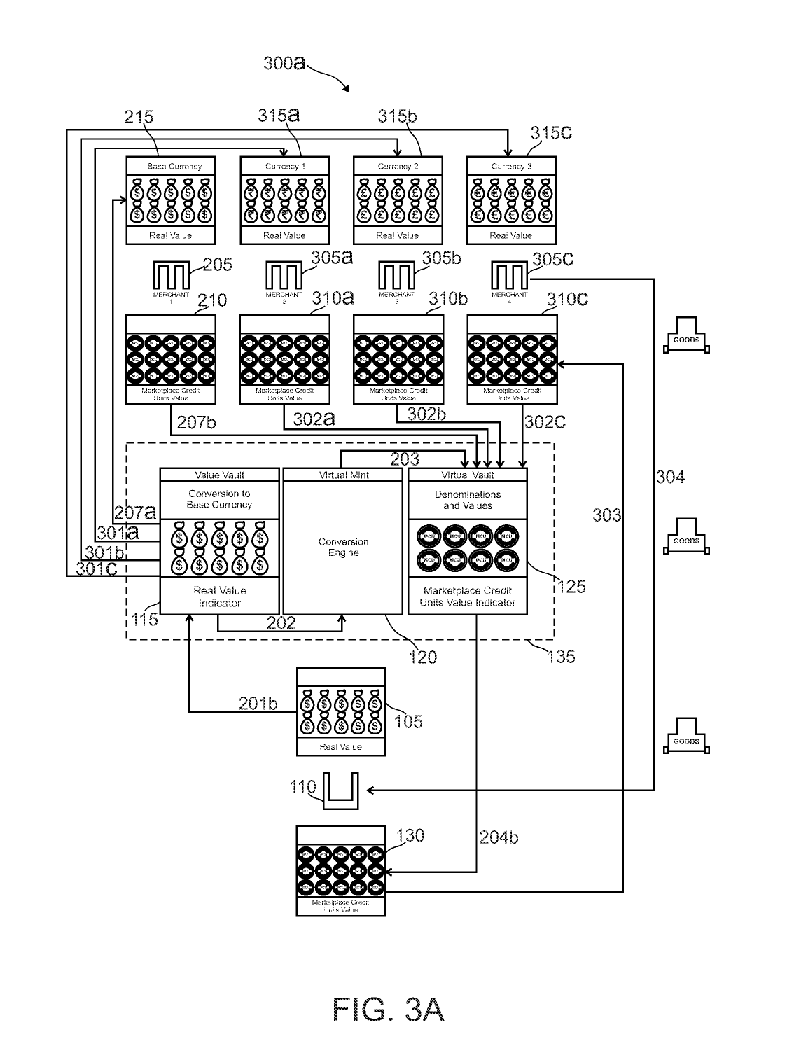

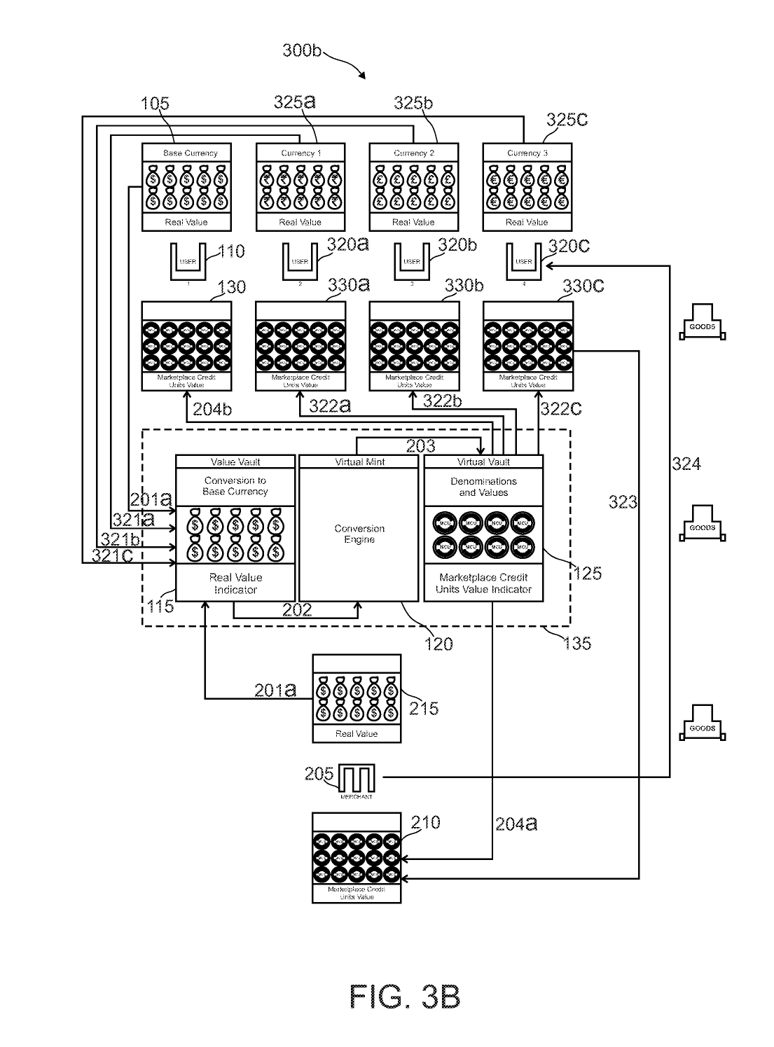

FIG. 3a illustrates a flow diagram 300a of interaction of the user 110 and multiple merchants in the marketplace to facilitate a transaction, in accordance with an exemplary embodiment.

The flow diagram 300a depicts flow of MCUs among the merchant 205, a merchant 305a, a merchant 305b, a merchant 305c and the user 110. Workflows for the merchant 305a, the merchant 305b and the merchant 305c remains almost similar to that of the merchant 205 (and as explained in FIG. 2) except that of currency. The merchant 205 transacts in a first currency, for example US dollars. In one example, the merchant 305a, the merchant 305b and the merchant 305c transacts in different currencies. In the example, the merchant 305a transacts in INR, the merchant 305b in British Pound and the merchant 305c in Euros. The merchants may either directly deposit the money in respective currencies in the vault 115, if the entity owning the system 135 allows, else the merchants may convert it into US dollars and then deposit. Alternatively, the system 135 may accept the money in respective currencies and maintain a database with relative mappings of different currencies. Also, a direct mapping of MCUs against different currencies can be maintained. Money in the different currencies (including second currency) may get converted into an equivalent value in the first currency. Post conversion, the interaction between the merchants and the system 135 may be similar to that described for the merchant 205 in FIG. 2. During redemption also appropriate conversion of currency may happen and money in appropriate currencies can be provided.

The merchants map their products or offerings against the MCUs and then put the products or offerings up in the marketplace for purchase by customers, for example the user 110. Against each product number of MCUs required for purchasing the product can be displayed.

Though the description has been provided using product offerings verses MCUs, it will be appreciated that the mappings can be done for different services, products, loyalty points, reward points, activities of the user 110, social activities, and against each head number of MCUs required or earned can be put. The MCUs allow for rewarding of the user 110 for its usage of online communities, web portals, social networks, email services, e-commerce sites, web sites, all kinds of electronic services or the offerings of all kinds of online and offline businesses, with discounts and loyalty rewards in the form of MCUs.

The user 110 deposits money 105 in the vault 115 (step 201b). The money 105 is sent to the conversion engine 120 (step 202). The conversion engine 120 converts the money 105 into the MCUs 130 (step 203) and the virtual vault 125 issues the MCUs 130 having value equivalent to that of the money 105 to the user 110 (step 204b).

In illustrated example, the user 110 decides to purchase a good from the merchant 305c. The user 110 pays the price in terms of MCUs to the merchant 305c (step 303). The transaction is facilitated using the MCUs 130 or portion of the MCUs 130 by the user 110. The merchant 305c facilitates delivery of the good purchased to the user 110 (step 304). Similar, purchase workflow exists for the merchant 305a, the merchant 305b and the merchant 205. Despite merchants preferring transactions in different currencies, a standard way of purchase with a standard mode of payment (MCUs) can be followed using the MCUs.

In a similar manner, the merchants may offer goods to other users and collect MCUs. The MCUs can then be exchanged for real money from the system 135. For example, the merchant 305a can redeem MCUs 310a (step 302a) and equivalent money 315a in appropriate currency is transferred to the merchant 305a by the system 135 (step 301a). The merchant 305b can redeem MCUs 310b (step 302b) and equivalent money 315b in appropriate currency is transferred to the merchant 305b by the system 135 (step 301b). The merchant 305c can redeem MCUs 310c (step 302c) and equivalent money 315c in appropriate currency is transferred to the merchant 305c by the system 135 (step 301c).

FIG. 3b illustrates a flow diagram 300b of interaction of multiple users and the merchant 205 in the marketplace to facilitate a transaction, in accordance with an exemplary embodiment.

The merchant 205 deposits money 215 in the vault 115 (step 201a). The money 215 is sent to the conversion engine 120 (step 202). The conversion engine 120 converts the money 215 into the MCUs 210 (step 203) and the virtual vault 125 issues the MCUs 210 having value equivalent to that of the money 215 to the merchant 205 (step 204a).

In various embodiments, the merchant 205 maps its products or offerings against the MCUs and then puts the products or offerings up in the marketplace for purchase by customers, for example the user 110. Against each product, number of MCUs required for purchasing the product can be displayed.

The user 110 deposits money 105 in the vault 115 (step 201b). The money 105 is sent to the conversion engine 120 (step 202). The conversion engine 120 converts the money 105 into the MCUs 130 (step 203) and the virtual vault 125 issues the MCUs 130 having value equivalent to that of the money 105 to the user 110 (step 204b).

The workflow for other users, for example a user 320a, a user 320b and a user 320c remains same as that of the user 110 except that of the currency. The user 110 transacts in a first currency, for example US dollars. In one example, the user 320a, the user 320b and the user 320c transacts in different currencies. In the example, the user 320a transacts in INR, the user 320b in British Pound and the user 320 in Euros. The users may be based out of different locations or countries. The users may either directly deposit the money in respective currencies in the vault 115, if the entity owning the system 135 allows, else the users may convert it into US dollars and then deposit. Alternatively, the system 135 may accept the money in respective currencies and maintain a database with relative mappings of different currencies. Also, a direct mapping of MCUs against different currencies can be maintained. Money in the different currencies (including second currency) may get converted into an equivalent value in the first currency. Post conversion, the interaction between the users and the system 135 may be similar to that described for the user 110 in FIG. 1. During redemption also appropriate conversion of currency may happen and money in appropriate currencies can be provided.

The user 320a deposits money 325a in the vault 115 (step 321a) and gets MCUs 330a issued by the system 135 (step 322a). The MCUs 330a have value equivalent to that of the money 325a. The user 320b deposits money 325b in the vault 115 (step 321b) and gets MCUs 330b issued by the system 135 (step 322b). The MCUs 330b have value equivalent to that of the money 325b. The user 320c deposits money 325c in the vault 115 (step 321c) and gets MCUs 330c issued by the system 135 (step 322c). The MCUs 330c have value equivalent to that of the money 325c.

In illustrated example, the user 320c then goes to a website of the merchant 205 and selects a good for purchase. The user 320c pays for the good using the MCUs 330c or a portion of the MCUs 330c (step 323). The merchant then facilitates delivery of the good to the user 320c (step 324).

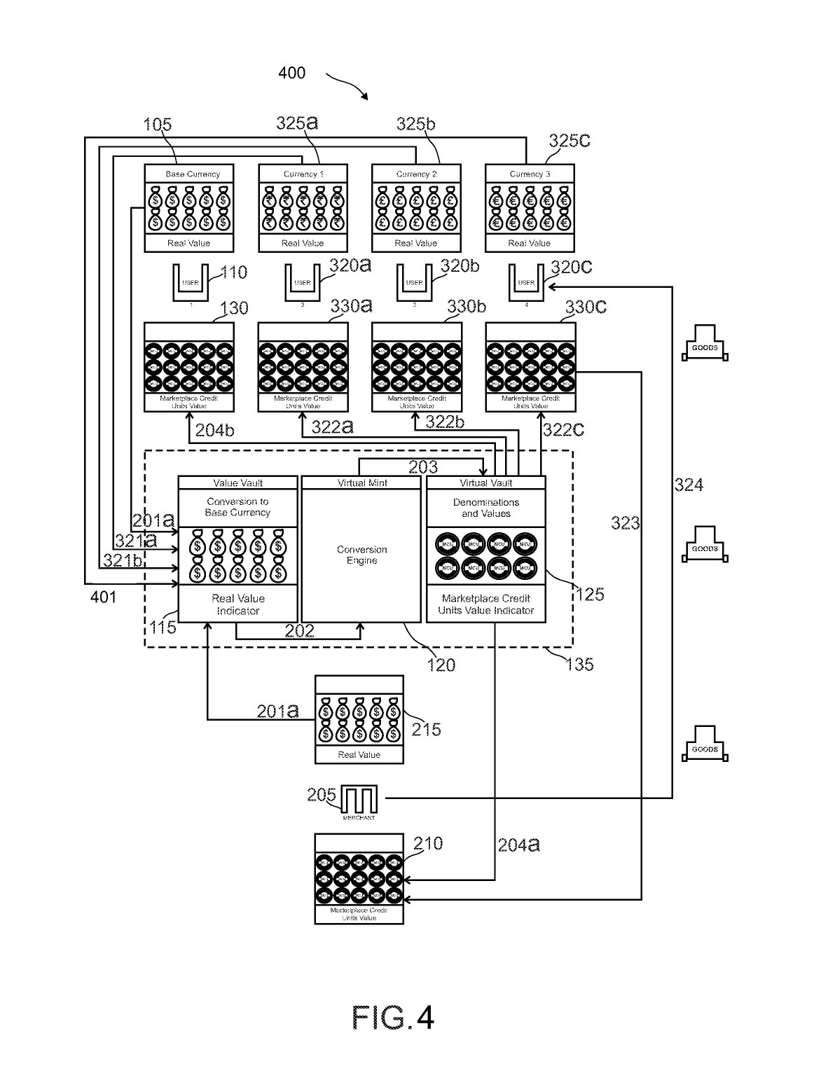

FIG. 4 illustrates a flow diagram 400 of interaction of the merchant in the marketplace to offer MCUs to multiple users, in accordance with an exemplary embodiment.

The flow diagram 400 remains similar to that explained in FIG. 3b except addition of step 401. In step 401, the merchant 205 offers the MCUs as loyalty points or reward points or benefits or bonus to the users. The merchant 205 may decide to do so based on number of parameters, i.e. number of goods purchased by the users, users' history, and users' participation on portal of the merchant 205 and so on. The MCUs get credited to the users MCU account. The users can then use these MCUs along with other MCUs they have for purchasing goods or redemption.

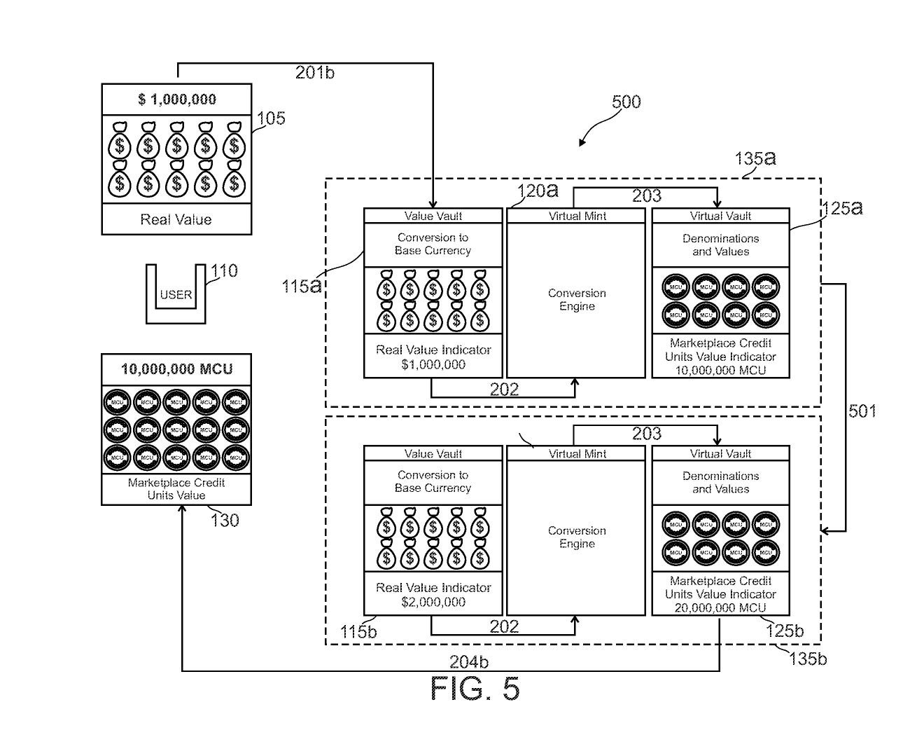

FIG. 5 illustrates flow diagram 500 of infusing more number of MCUs in the marketplace by infusing more money in the marketplace, in accordance with an exemplary embodiment.

The flow diagram 500 indicates two instances of the system 135, for example instance 135a and instance 135b. The user 110 deposits money 105 (USD 1 million) in the vault 115a (step 201b). The money 105 is sent to the conversion engine 120a (step 202). The conversion engine 120 converts the money 105 into the MCUs 130 (step 203) and the virtual vault 125a issues the MCUs 130 having value equivalent to that of the money 105 to the user 110 (step 204b).

The vault 115a, the conversion engine 120a and the virtual vault 125a are locked. The value locked in real terms in the vault 115a, and the total worth of the MCUs introduced or released into the instance 135a are locked. At any given point of time, the sum total of real and MCUs are open to audit and a real-time measure is given. Any new introduction or withdrawal of real value into or from the vault 115a triggers an equivalent impact of additional release or withdrawal of the MCUs.

In illustrated example, another USD 1 million is infused in the marketplace, for example by the user 110. The additional amount can be infused by any entity, for example users, merchants etc. The instance 135a then gets replaced by the instance 135b (step 501). The vault 115b gets the additional USD 1 million making total to USD 2 million. The conversion 120b converts the USD 2 million to equivalent MCUs and the mapping is maintained along with appropriate denominations by the virtual vault 125b.

The replacement of the instance 135a by the instance 135b and locking ensures the objectives of keeping the total value exchange system as being backed by real currency and thus has a fixed real value. At any given point of time, any recipient is assured of being given back a real value or currency in exchange of the MCUs.

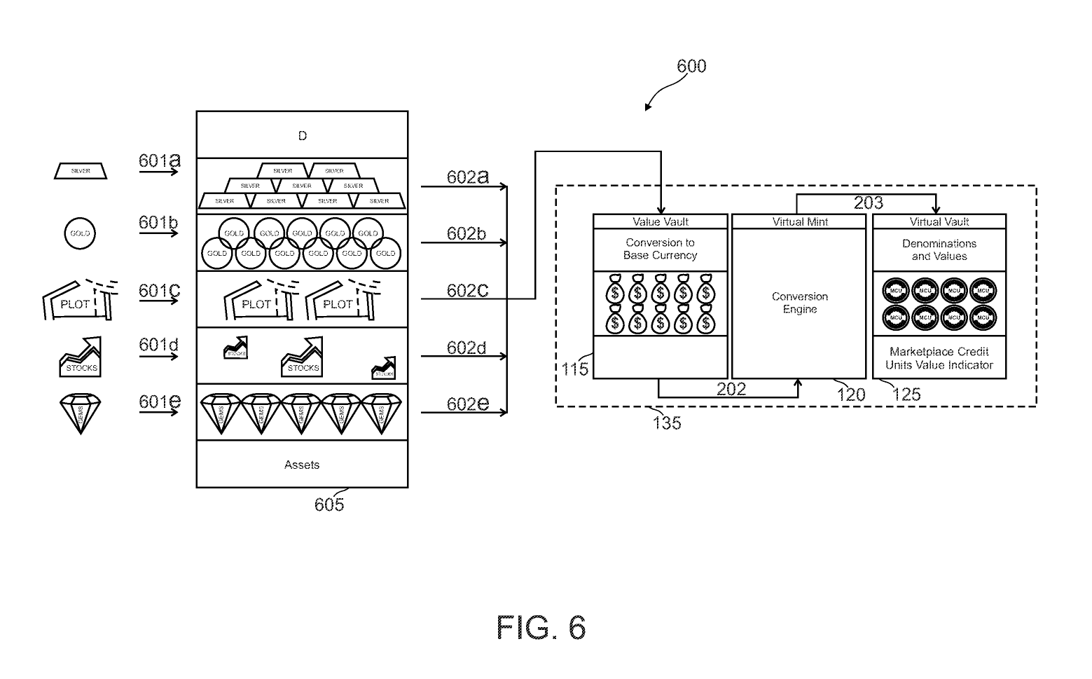

FIG. 6 illustrates a flow diagram 600 of changing backing of value of the MCUs from money to assets, in accordance with an exemplary embodiment. A same user or many different users or merchants or entity running the system 135 may decide to use assets 605 to purchase the MCUs. The entities may use assets to back the MCUs or the system 135 with secure appreciating assets rather than fluctuating currencies. In such scenario, the system 135 provides an option to the users to do so. For example, a user may decide to use gold bar, gold coin, plot, stocks, diamond etc., as indicated in steps 601a, 601b, 601c, 601d, and 601e respectively, to purchase MCUs. In one embodiment, the assets 605 are sent to the vault 115 where the vault 115 converts the assets 605 into equivalent value of money. The money is then converted into MCUs using the conversion engine 120 and then issued to the user. Alternatively, the users may convert these assets into money from other sources and deposit money in the vault 115. Various possible assets acceptable to the entity owning the system 135 can be used.

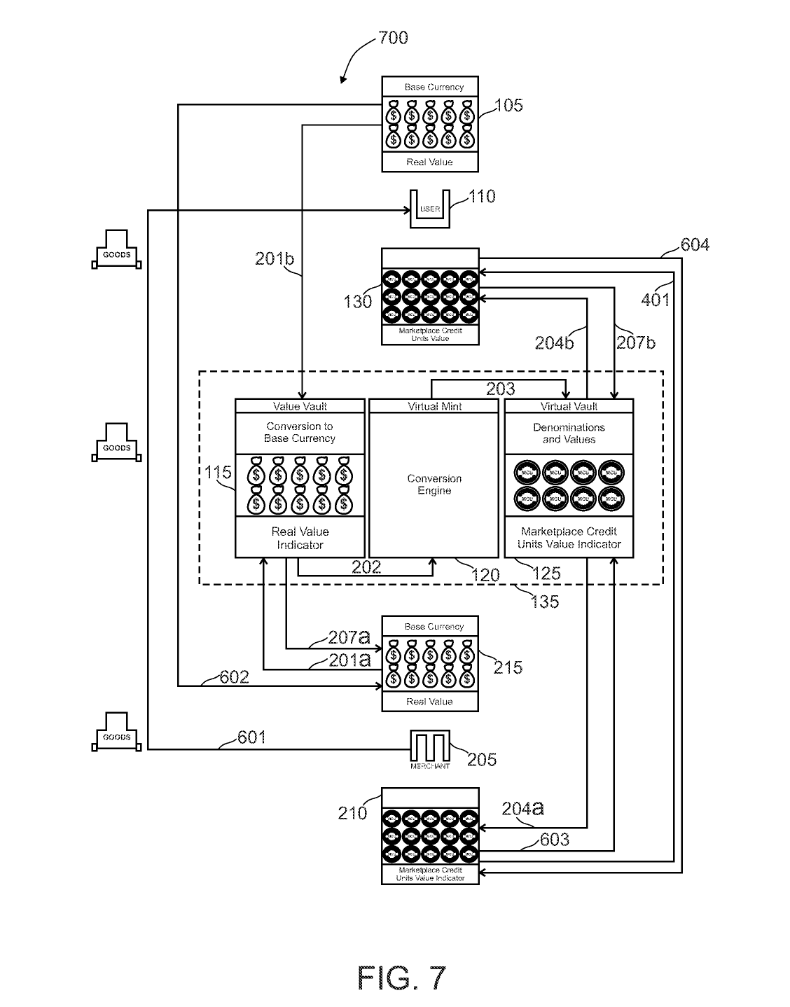

FIG. 7 illustrates a flow diagram 700 of revenue settlement cycle between the user and the merchant in the marketplace, in accordance with an exemplary embodiment. The workflow for the user 110 and the merchant 205 remains the same as explained in FIG. 2, FIG. 3a, FIG. 3b and FIG. 4 except the steps 601, 602, 603, and 604.

The merchant 205 deposits money 215 in the vault 115 (step 201a). The money 215 is sent to the conversion engine 120 (step 202). The conversion engine 120 converts the money 215 into the MCUs 210 (step 203) and the virtual vault 125 issues the MCUs 210 having value equivalent to that of the money 215 to the merchant 205 (step 204a).

In various embodiments, the merchant 205 maps its products or offerings against the MCUs and then puts the products or offerings up in the marketplace for purchase by customers, for example the user 110. Against each product, number of MCUs required for purchasing the product can be displayed.

The user 110 deposits money 105 in the vault 115 (step 201b). The money 105 is sent to the conversion engine 120 (step 202). The conversion engine 120 converts the money 105 into the MCUs 130 (step 203) and the virtual vault 125 issues the MCUs 130 having value equivalent to that of the money 105 to the user 110 (step 204b).

In illustrated example, the user 110 browses through the portal of the merchant 205 and decides to purchase a good. The user opts to make a payment using MCUs. The payment is received by the merchant 205 in MCUs (step 604). The merchant 205 then facilitates delivery of the good to the user 110 (step 601). In one embodiment, the user 110 may opt to pay the merchant 205 in real money (step 602). The merchant 205 then facilitates delivery of the good to the user 110 (step 601).

In illustrated example, the merchant 205 offers the MCUs as loyalty points or reward points or benefits or bonus to the user 110. The merchant 205 may decide to do so based on number of parameters, i.e. number of goods purchased by the users, users' history, and users' participation on portal of the merchant 205 and so on. The MCUs get credited to the MCU account of the user 110 (step 401).

Either of the merchant 205 (step 603) or the user 110 (step may then redeem their MCUs from the system 135 at any point of time. The money equivalent to redeemed MCUs is then transferred to the merchant 205 (step 207a) and to the user 110 (step 207b) by the system 135.

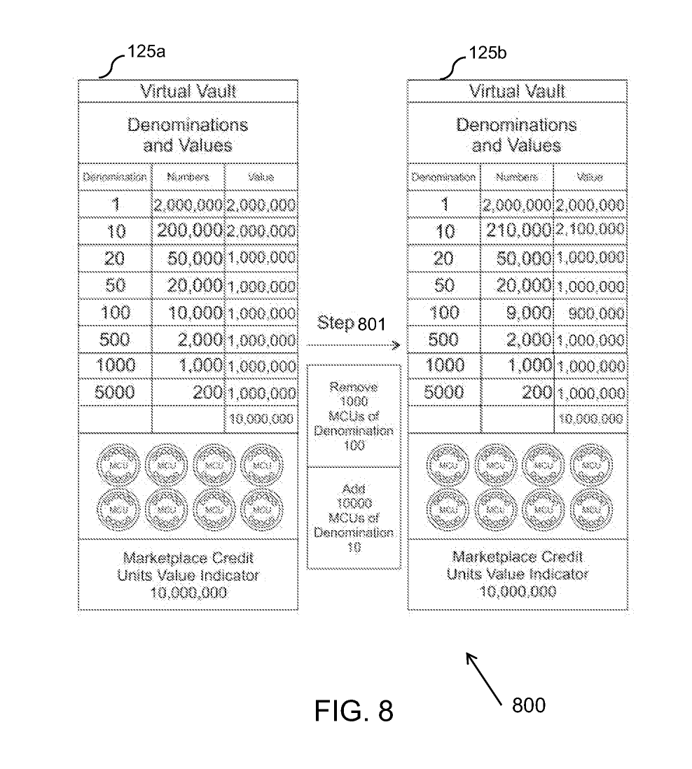

FIG. 8 illustrates a flow diagram 800 of changing denomination of the MCUs in the marketplace, in accordance with an exemplary embodiment. The flow diagram 800 shows two instances of the virtual vault, for example a virtual vault 125a and a virtual vault 125b. In the virtual vault 125a 10 million MCUs are mapped to different denominations. In illustrated example, it is required to remove 1000 MCUs of denomination 100 and to add 10000 MCUs of denomination 10 due to shortage of MCUs with denomination 10 or due to need of replacement. The change is done by the system 135 (step 801). The appropriate calculations are done by the system 135 and corresponding changes are done in the virtual vault 125a to change it to the virtual vault 125b.

The system 135 can introduce or remove or replace an MCU with a particular denomination value, based on usage and necessity. The system 135 can also remove a certain number of MCUs of a given denomination value partially, and replace these MCUs with an equivalent value MCUs of another denomination. For example, on finding that the system 135 needs more MCUs of denomination 20 as they are being used often and less MCUs of denomination 50, the system 135 may decide to partially remove half of existing MCUs of denomination 50. In one example, there are 20,000 MCUs of denomination 50. Hence, 10,000 MCUs of denomination 50 are withdrawn and killed. Since 10,000 MCUs of denomination 50 represent a virtual value of 500,000, it would result in creation of 25,000 MCUs of denomination 20.

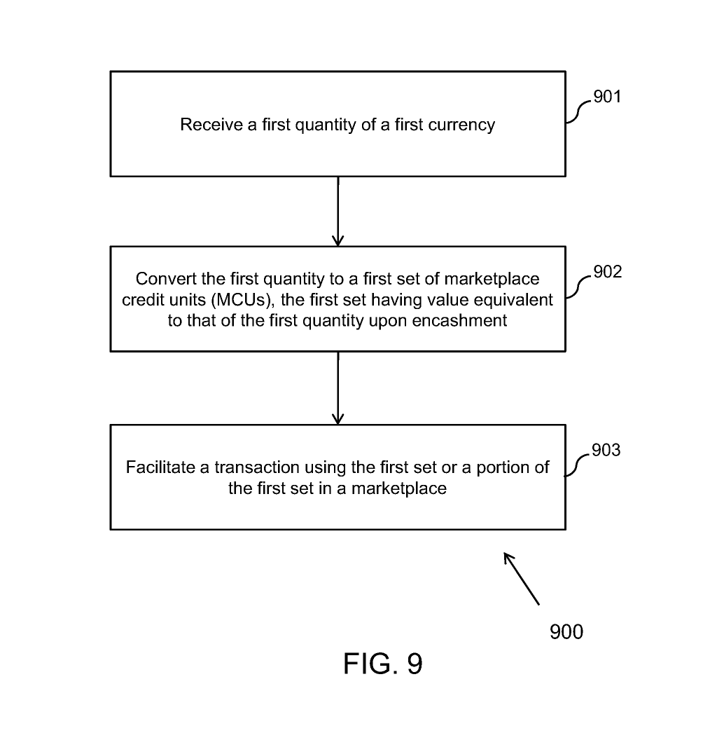

FIG. 9 is a flowchart depicting an exemplary method of enabling a transaction in the marketplace, in accordance with an exemplary embodiment. The method can be performed by, for example the system 135.

At step 901, a first quantity of a first currency is received. The first quantity may be received by, for example the vault 115. The first quantity can be received from a user or a merchant.

At step 902, the first quantity is converted into a first set of marketplace credit units (MCUs). The first set has value equivalent to that of the first quantity upon encashment. The conversion can be performed using, for example the converting engine 120 and the virtual vault 125.

In some embodiments, a unique identifier is also generated and assigned to each MCU. The unique identifier helps in identifying the MCU. The MCU has capability of facilitating a transaction as it has a real value associated to it.

Post conversion the first set is issued. The first set is stored in at least one of an electronic card, smart card, mobile phone, electronic chip, and account of the user or the merchant.

At step 903, a transaction is facilitated using the MCUs. The merchant can provide mappings for its products against the MCUs and the user interested in purchasing a product can do so using the MCUs. The payment is received by merchant portal in form of MCUs and transaction occurs. The product can then be delivered to the user.

At any point of time, the MCUs can be redeemed. The system 135 receives the MCUs (at least one MCU) for encashment and converts the MCUs to appropriate value of the first currency. In some embodiments, if the MCUs are issued in response to receipt of second currency then the MCUs may be converted to the second currency during redemption. Issuing of MCUs in response to receipt of a second quantity of the second currency includes converting the second quantity into equivalent value of the first currency and converting the equivalent value of the first currency into MCUs.

In some embodiments, the MCUs can be offered as rewards, loyalty points, etc., and can also be issued against assets. Appropriate value in first currency of these assets can be deduced and corresponding MCUs can be issued.

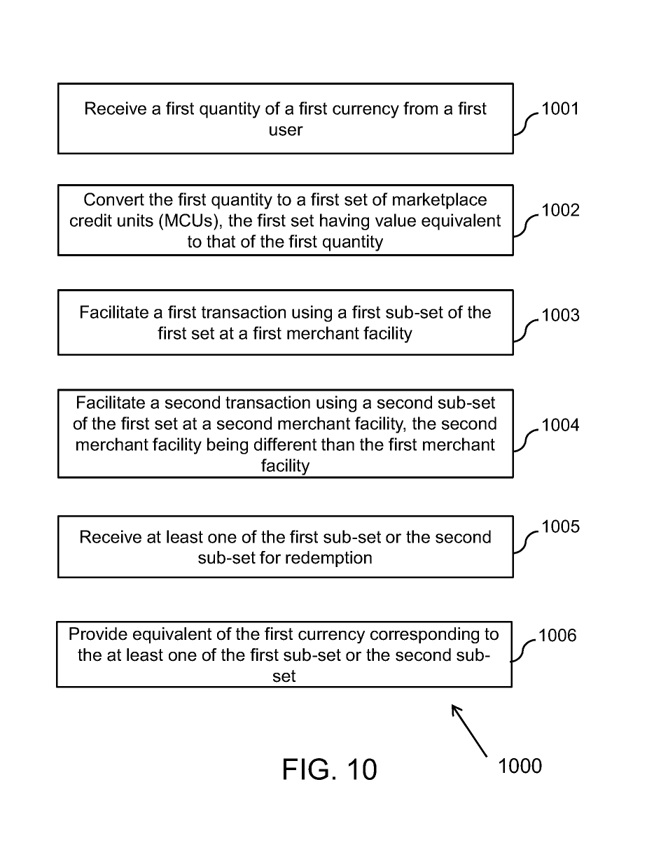

FIG. 10 is a flowchart depicting an exemplary method of enabling multiple transactions in the marketplace, in accordance with another exemplary embodiment.

At step 1001, a first quantity of a first currency from a first user is received by, for example, the system 135.

At step 1002, the first quantity is converted to a first set of marketplace credit units (MCUs). This first set of MCUs has value equivalent to that of the first quantity.

At step 1003, a first transaction is facilitated using a first sub-set of the first set at a first merchant facility. The first sub-set includes one or more MCUs of the first set.

At step 1004, a second transaction is facilitated using a second sub-set of the first set at a second merchant facility. The second merchant facility is different than the first merchant facility.

At step 1005, at least one of the first sub-set or the second sub-set is received for redemption. Any one of the merchants or both may want to redeem their MCUs.

At step 1006, value of the first currency equivalent to number of MCUs received for redemption is provided. The value corresponds to the at least one of the first sub-set or the second sub-set or both.

In one example, the first merchant and the second merchant are based out of different locations and are not capable of accepting payments in the first currency. In such scenario, the payment is facilitated using MCU. For example, the first merchant is based out of India and accepts payment only in INR, and the second merchant is based out of Japan and accepts payment only in Yen. Further, the user is based out of Mauritius and can make payment only in Mauritian Rupee. The use of MCUs facilitates a transaction here.

In one example, the system 135 involves the release of MCUs by a party which also governs an online and offline integrated marketplace that allows participating businesses to offer goods and services online or offline for purchase or hire. All MCUs have a single chosen currency equivalent and are then, through a globally relevant currency conversion program, pegged for usage into any global currency. Hence, it can be used globally.

Common forms of non-transitory computer-readable storage medium include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer may read.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed is:

1. A method comprising:
i. receiving a first quantity of a first currency;
ii. electronically converting the first quantity to a first set of marketplace credit units (MCUs), the first set having value equivalent to that of the first quantity upon encashment; and
iii. facilitating a transaction using the first set or a portion of the first set in a marketplace.

2. The method of claim 1, wherein the converting comprises:
associating a unique identifier with each MCU.

3. The method of claim 2 further comprising:
issuing the first set, wherein the first set is stored in at least one of an electronic card, smart card, mobile phone, electronic chip, and account.

4. The method of claim 1, wherein the transaction comprises at least one of:
i. an online transaction; and
ii. an offline transaction.

5. The method of claim 1 further comprising:
converting the first set to a second set of MCUs, the first set and the second set having at least one different denomination of MCU and the second set having value equivalent to that of the first quantity upon encashment.

6. The method of claim 1 further comprising:
i. receiving at least one MCU for encashment; and
ii. converting the at least one MCU to appropriate value of the first currency or a second currency.

7. The method of claim 1 further comprising:
i. receiving a second quantity of a second currency;
ii. converting the second quantity of the second currency into equivalent value of the first currency; and
iii. converting the equivalent value of the first currency into MCUs.

8. The method of claim 1 further comprising:
providing MCUs as at least one of rewards, offers, discounts and benefits.

9. The method of claim 1, wherein the receiving comprises:
i. receiving at least one item from group consisting of assets, commodities, gold, silver, stocks, guarantees, and property papers; and
ii. converting the at least one item into the first quantity of the first currency.

10. A non-transitory, computer-readable storage medium storing computer-executable program instructions to implement:
i. receiving a first quantity of a first currency; and
ii. converting the first quantity to a first set of marketplace credit units (MCUs), the first set having value equivalent to that of the first quantity upon encashment, each MCU having a unique identifier and having capability of facilitating a transaction in a marketplace.

11. The medium of claim 10 further comprising instructions to implement:
converting the first set to a second set of MCUs, the first set and the second set having at least one different denomination of MCUs and the second set having value equivalent to that of the first quantity upon encashment.

12. The medium of claim 10 further comprising instructions to implement:
facilitating a transaction using the first set or a portion of the first set.

13. The medium of claim 10 further comprising instructions to implement:
i. receiving at least one MCU for encashment; and
ii. converting the at least one MCU to appropriate value of the first currency or a second currency.

14. The medium of claim 10 further comprising instructions to implement:
i. receiving a second quantity of a second currency;
ii. converting the second quantity of the second currency into equivalent value of the first currency; and
iii. converting the equivalent value of the first currency into MCUs.

15. The medium of claim 10 further comprising instructions to implement:
providing MCUs as at least one of rewards, offers, discounts and benefits.

16. The medium of claim 10, wherein the receiving comprises:
i. receiving at least one item from group consisting of assets, commodities, gold, silver, stocks, guarantees, and property papers; and
ii. converting the at least one item into the first quantity of the first currency.

17. A system comprising:
a memory to store instructions; and
a processor responsive to stored instructions to perform i. receiving a first quantity of a first currency;
ii. converting the first quantity to a first set of marketplace credit units (MCUs), the first set having value equivalent to that of the first quantity upon encashment, each MCU having a unique identifier; and
iii. facilitating a transaction using the first set or a portion of the first set in a marketplace.

18. The system of claim 17 further comprising a vault to store the first currency.

19. The system of claim 17, wherein processor is responsive to stored instructions to further perform:
converting the first set to a second set of MCUs, the first set and the second set having at least one different denomination of MCU and the second set having value equivalent to that of the first quantity upon encashment.

20. The system of claim 17, wherein processor is responsive to stored instructions to further perform:
i. receiving at least one MCU for encashment; and
ii. converting the at least one MCU to appropriate value of the first currency or a second currency.

21. The system of claim 17, wherein processor is responsive to stored instructions to further perform:
i. receiving a second quantity of a second currency;
ii. converting the second quantity of the second currency into equivalent value of the first currency; and
iii. converting the equivalent value of the first currency into MCUs.

22. The system of claim 17, wherein processor is responsive to stored instructions to further perform:
providing MCUs as at least one of rewards, offers, discounts and benefits.

23. The system of claim 17, wherein processor is responsive to stored instructions to further perform:
i. receiving at least one item from group consisting of assets, commodities, gold, silver, stocks, guarantees, and property papers; and
ii. converting the at least one item into the first quantity of the first currency.

24. The system of claim 17, wherein processor is responsive to stored instructions to further perform:
associating a unique identifier with each MCU.

25. A method comprising:
i. receiving a first quantity of a first currency from a first user;
ii. electronically converting the first quantity to a first set of marketplace credit units (MCUs), the first marketplace credit unit having value equivalent to that of the first quantity;
iii. facilitating a first transaction using a first sub-set of the first set at a first merchant facility;
iv. facilitating a second transaction using a second sub-set of the first set at a second merchant facility, the second merchant facility being different than the first merchant facility;
v. receiving at least one of the first sub-set or the second sub-set for redemption; and
vi. providing equivalent of the first currency corresponding to the at least one of the first sub-set or the second sub-set.

26. The method of claim 25, wherein the first merchant and the second merchant are based out of different locations and are not capable of accepting payments in the first currency.
